(19) United States
(12) Patent Application Publication
(10) Pub. No.: US 2024/0257577 A1
(43) Pub. Date: Aug. 1, 2024

(54) INFORMATION PROCESSING DEVICE

(71) Applicant: TOYOTA JIDOSHA KABUSHIKI KAISHA, Toyota-shi (JP)

(72) Inventors: Yohsuke HASHIMOTO, Nagakute-shi (JP); Satoshi AKIMA, Nagakute-shi (JP)

(73) Assignee: TOYOTA JIDOSHA KABUSHIKI KAISHA, Toyota-shi (JP)

(21) Appl. No.: 18/534,913

(22) Filed: Dec. 11, 2023

(30) Foreign Application Priority Data
Jan. 26, 2023 (JP) 2023-010450

(51) Int. Cl. G07C 5/00; G07C 5/08

(52) U.S. Cl. CPC G07C 5/008; G07C 5/0808

(57) ABSTRACT

The control unit of the information processing device acquires a first frequency that is the frequency of lane changes per unit time of the first vehicle. The control unit performs a first driving diagnosis based on the first frequency. When the result of the first driving diagnosis satisfies the first condition, the control unit transmits, to a first terminal, first information about first equipment that is equipment for assisting driving operation related to lane change and is equipment that can be attached to the first vehicle, and the result of a first driving diagnosis.

### CROSS-REFERENCE TO RELATED APPLICATION

This application claims priority to Japanese Patent Application No. 2023-010450 filed on Jan. 26, 2023, incorporated herein by reference in its entirety.

### BACKGROUND

### 1. Technical Field

The present disclosure relates to an information processing device.

### 2. Description of Related Art

A technique for acquiring the number of lane changes per unit distance while a vehicle is running is known (for example, Japanese Unexamined Patent Application Publication No. 2014-164452 (JP 2014-164452 A)).

### SUMMARY

An object of the present disclosure is to provide an effective technique for improving the safety of a user who drives a vehicle.

One aspect of the present disclosure provides an information processing device. The information processing device in that case may include a control unit that executes, for example:
acquiring a first frequency that is a frequency of a lane change per unit time of a first vehicle; performing a first driving diagnosis based on the first frequency; and
transmitting first information and a result of the first driving diagnosis to a first terminal when the result of the first driving diagnosis satisfies a first condition. The first information is information about first equipment that is equipment for assisting a driving operation related to the lane change and is equipment that is able to be attached to the first vehicle.

The present disclosure can also be regarded as an information processing method in which a computer executes processes of the above information processing device. Further, the present disclosure can be regarded as a program for causing a computer to execute the above information processing method, or a storage medium that not-temporarily stores the program.

According to the present disclosure, it is possible to provide an effective technique for improving the safety of a user who drives a vehicle.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 is a diagram showing a schematic configuration of a system according to an embodiment;

FIG. 2 is a diagram showing a hardware configuration example of each of a first vehicle, a user terminal, and a server included in the system according to the embodiment;

FIG. 3 is a block diagram showing an example of functional configurations of an ECU, a user terminal, and a server according to the embodiment;

FIG. 4 is a diagram showing an example of information stored in a vehicle information DB according to this embodiment;

FIG. 5 is a flowchart illustrating an example of a processing routine executed by the server according to the embodiment; and

FIG. 6 is a flowchart illustrating an example of a processing routine executed by the server according to the modification.

### DETAILED DESCRIPTION OF EMBODIMENTS

Conventionally, there has been known a technique of diagnosing driving of a user of a vehicle and notifying the user of the diagnosis result. The user notified of such diagnosis results can objectively grasp the tendency of his or her own driving operation.

Here, lane change can be considered as one of the items targeted for driving diagnosis. As for lane changes, users who tend to change lanes easily, users who tend not to change lanes, or the like are assumed. These users need a way to safely change lanes.

Therefore, in the information processing device that is one aspect of the present disclosure, the control unit acquires a first frequency that is the frequency of lane changes per unit time of the first vehicle. The “first frequency” referred to here may be, for example, the ratio of the total number of lane changes to the total driving time of the first vehicle in a predetermined period (for example, several weeks to several months). In this case, trips in which the number of lane changes is less than a lower limit value (for example, about 0 to 1) may be excluded from the total driving time and the total number of lane changes. This is because in trips where the number of lane changes is less than the lower limit, there is a high possibility that the first vehicle traveled on a single-lane road (a road on which lane changes cannot be made). Further, when multiple trips are made per day, only the driving time and the number of lane changes of the trip with the largest number of lane changes may be counted.

The control unit of the information processing device according to the present disclosure performs the first driving diagnosis based on the first frequency described above. In the first driving diagnosis, for example, the control unit determines whether the first frequency satisfies the first condition. The “first condition” here is a condition under which it can be determined that the user of the first vehicle tends to change lanes easily, and the first frequency is equal to or greater than the first threshold (for example, about 5 times) or more. Further, the “first condition” may be a condition under which it can be determined that the user of the first vehicle tends to have difficulty changing lanes. The first condition in that case is, for example, that the first frequency is equal to or less than a second threshold (for example, about twice).

The control unit of the information processing device according to the present disclosure transmits, to the first terminal, first information and the diagnosis result of the first driving diagnosis, when the diagnosis result of the first driving diagnosis satisfies a first condition (for example, when the first frequency is equal to or greater than the first threshold, or when the first frequency is equal to or less than the second threshold). The first information is information for recommending the first equipment. The first equipment is, for example, equipment for assisting driving operations related to lane changes and is equipment that can be attached to the first vehicle.

According to the information processing device according to the present disclosure, it is possible to provide first equipment suitable for assisting a driving operation related to changing lanes for a user who tends to change lanes easily and a user who tends not to change lanes easily (e.g., Blind Spot Monitor (BSM), etc.).

Hereinafter, embodiments of the present disclosure will be described with reference to the drawings. The configurations of the following embodiments are illustrative, and the present disclosure is not limited to the configurations of the embodiments. Further, the following embodiments can be combined as much as possible.

### Embodiment

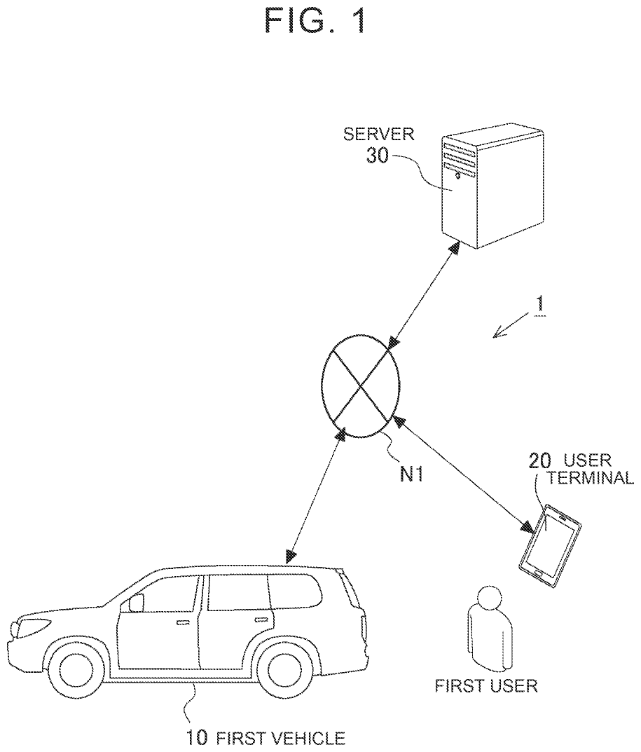

FIG. 1 is a diagram showing a schematic configuration of a system 1 according to the present embodiment. The system 1 is a system for providing a service for diagnosing the driving operation of the first vehicle 10 by the first user and providing the diagnosis result to the first user (hereinafter also referred to as “driving diagnosis service”).

In the example of FIG. 1, system 1 includes first vehicle 10, user terminal 20 and server 30. A first vehicle 10 is a vehicle driven by a first user. The user terminal 20 is a terminal used by the first user. The server 30 performs a driving diagnosis on the driving operation of the first vehicle 10 and provides the user terminal 20 with the diagnosis result. The server 30 of the present embodiment performs driving diagnosis related to the lane change of the first vehicle 10. If the driving diagnosis result satisfies a predetermined condition, the server 30 provides the user terminal 20 with the first information in addition to the diagnosis result. The first information is information about equipment (first equipment) that is equipment for assisting driving operations related to lane changes and that can be attached to the first vehicle 10. The user terminal 20 presents the diagnosis result (and the first information) provided by the server 30 to the first user.

The first vehicle 10, the user terminal 20 and the server 30 are interconnected by a network N1. The network N1 is, for example, a Wide Area Network (WAN), which is a worldwide public communication network such as the Internet, or another communication network. The network N1 may include a telephone communication network such as a mobile phone and/or a wireless communication network such as Wi-Fi (registered trademark). Note that the first vehicle 10 may be connected to the user terminal 20 via short-range wireless communication. Although one first vehicle 10 is illustrated in FIG. 1 as an example, a plurality of first vehicles 10 may exist. Also, a plurality of user terminals 20 may exist according to the number of first vehicles 10.

### System Hardware Configuration

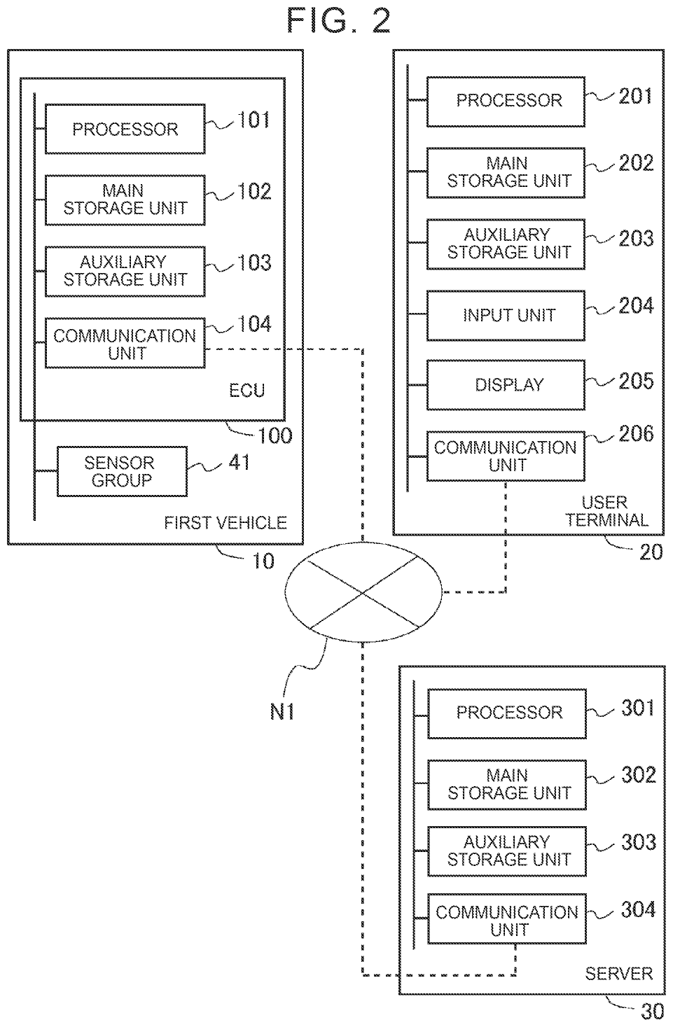

FIG. 2 is a diagram showing an example of the hardware configuration of each of the first vehicle 10, the user terminal 20, and the server 30. In the example shown in FIG. 2, only the hardware configuration related to the driving diagnosis service is extracted and illustrated, but each of the first vehicle 10, the user terminal 20, and the server 30 may 30 may include other hardware configuration.

The first vehicle 10 has an ECU 100 and a sensor group 41. These components are interconnected by an in-vehicle network based on standards such as Controller Area Network (CAN), Local Interconnect Network (LIN), or FlexRay. Note that each of these components may be realized by a combination of an in-vehicle device such as a car navigation system or an in-vehicle communication device instead of a single module.

The ECU 100 is a computer mounted on the first vehicle 10. The ECU 100 includes a processor 101, a main storage unit 102, an auxiliary storage unit 103 and a communication unit 104. The components are connected to each other by a bus.

The processor 101 is a Central Processing Unit (CPU), a Digital Signal Processor (DSP), or the like. The processor 101 controls the ECU 100 and performs various information processing operations. The main storage unit 102 includes a random access memory (RAM), a read only memory (ROM), and the like. The auxiliary storage unit 103 includes an Erasable Programmable ROM (EPROM), Hard Disk Drive (HDD), removable media, or the like. The auxiliary storage unit 103 stores an operating system (OS), various programs, various tables, and the like. The processor 101 loads the program stored in the auxiliary storage unit 103 into the work area of the main storage unit 102 and executes it, thereby controlling each component. As a result, the ECU 100 realizes a function that meets a predetermined purpose. The main storage unit 102 and the auxiliary storage unit 103 are computer-readable recording media. Note that part of the information stored in the auxiliary storage unit 103 may be stored in the main storage unit 102. Further, part of the information stored in the main storage unit 102 may be stored in the auxiliary storage unit 103.

The communication unit 104 is an interface for connecting the ECU 100 to the network N1. The communication unit 104 is a mobile communication service (for example, a telephone communication network such as 6th Generation (6G), 5th Generation (5G), 4th Generation (4G), 3rd Generation (3G), or Long Term Evolution (LTE)), Wi-Fi (registered trademark), or a wireless communication network such as Bluetooth (registered trademark) to communicate with other devices (e.g., server 30, etc.) via network N1.

The sensor group 41 includes, for example, sensors that detect the state of the first vehicle 10 and sensors that detect the actions of the driver. The sensor group 41 includes, for example, a speed sensor, an acceleration sensor, an accelerator operation amount sensor, a steering angle sensor, a yaw rate sensor, a turn signal switch sensor (a sensor that detects the switch state of a direction indicator), a shift position sensor, and a position information sensor. (GPS sensor), brake switch, camera, and the like. The sensor group 41 may also include a sensor that detects that a system such as pre-crash safety has been activated.

Next, the user terminal 20 is a computer used by the first user. The user terminal 20 is, for example, a smart phone, a mobile phone, a tablet terminal, a personal information terminal, a wearable computer (such as a smart watch), or a personal computer (PC). The user terminal 20 has a processor 201, a main storage unit 202, an auxiliary storage unit 203, an input unit 204, a display 205 and a communication unit 206. The components are connected to each other by a bus. Since the processor 201, the main storage unit 202, the auxiliary storage unit 203, and the communication unit 206 are the same as the processor 101, the main storage unit 102, the auxiliary storage unit 103, and the communication unit 104 of the ECU 100, the description thereof is omitted. Omitted.

The input unit 204 is a device that receives input operations performed by the first user, and includes, for example, a touch panel, a mouse, a keyboard, a microphone, or push buttons. A display 205 is a device that presents information to the first user, such as a Liquid Crystal Display (LCD) or an Electro luminescence (EL) panel. Note that the input unit 204 and the display 205 may be configured as one touch panel display.

Next, the server 30 is a computer operated by a driving diagnosis service provider. The server 30 has a processor 301, a main storage unit 302, an auxiliary storage unit 303, and a communication unit 304, as shown in FIG. 2. The components are connected to each other by a bus. The processor 301, the main storage unit 302 and the auxiliary storage unit 303 are the same as the processor 101, the main storage unit 102 and the auxiliary storage unit 103 of the ECU 100, so the description thereof will be omitted.

The communication unit 304 of the server 30 is an interface for connecting the server 30 to the network N1. The communication unit 304 includes, for example, a Local Area Network (LAN) interface board or a wireless communication circuit for wireless communication. In this embodiment, the communication unit 304 communicates with the first vehicle 10 and the user terminal 20 through the network N1.

### Functional Configuration of the System

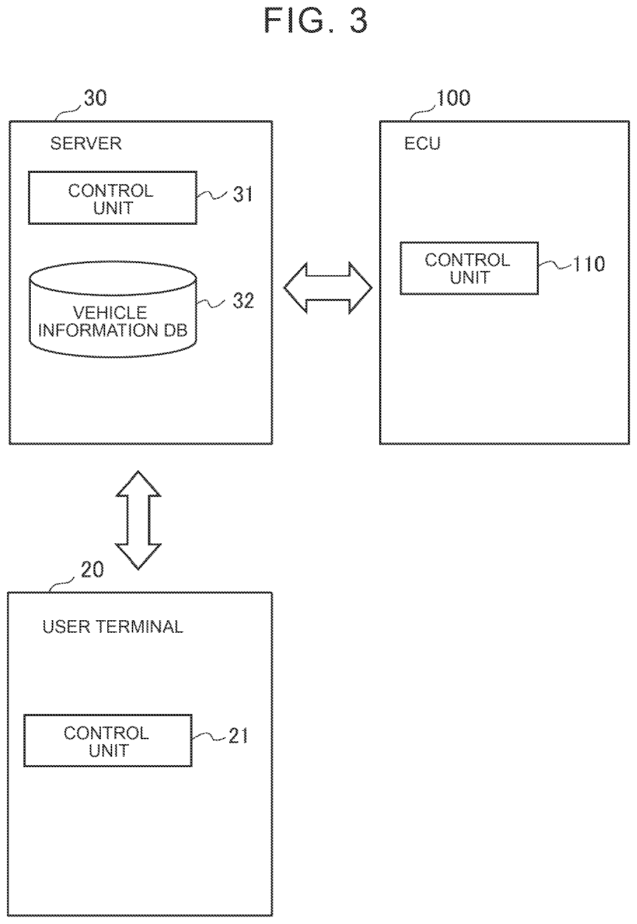

A functional configuration of the system 1 according to this embodiment will be described. FIG. 3 is a block diagram showing an example of functional configurations of each of the ECU 100, the user terminal 20, and the server 30. The functional configurations of the ECU 100, the user terminal 20, and the server 30 are not limited to the configurations illustrated in FIG. 3, and functional components can be omitted, changed, or added as appropriate.

As shown in FIG. 3, the ECU 100 has a control unit 110 as its functional component. Control unit 110 is achieved by processor 101 of ECU 100 executing a program stored in auxiliary storage unit 103. Note that the control unit 110 may be achieved by a hardware circuit such as an Application Specific Integrated Circuit (ASIC) or a Field Programmable Gate Array (FPGA).

The control unit 110 of the ECU 100 in this embodiment transmits travel information to the server 30 through the communication unit 104 each time the first vehicle 10 finishes traveling for one trip. The travel information is information including, for example, each detection value of the sensor group 41 during the trip, trip date and time (trip start date and time and trip end date and time), information (vehicle ID) for identifying the first vehicle 10, and the like. The “trip” here may be a period from when the first vehicle 10 is started (e.g., the ignition switch is turned on) to when it is stopped (e.g., the ignition switch is turned off), or a car navigation system or the like. It may be a period from when the first vehicle 10 starts traveling on the route from the starting point to the destination set to the destination until it finishes traveling.

The user terminal 20, as shown in FIG. 3, has a control unit 21 as its functional component. The control unit 21 is achieved by executing a program stored in the auxiliary storage unit 203 by the processor 201 of the user terminal 20. Note that the control unit 21 may be achieved by a hardware circuit such as an Application Specific Integrated Circuit (ASIC) or a Field Programmable Gate Array (FPGA).

The control unit 21 of the user terminal 20 in this embodiment presents the diagnosis result (and the first information) provided from the server 30 to the first user. Specifically, when the communication unit 206 of the user terminal 20 receives the diagnosis result (and the first information) transmitted from the server 30, the control unit 21 transmits the diagnosis result (and the first information) to Displayed on the display 205 of the user terminal 20.

Next, the functional configuration of the server 30 will be described. The server 30 in this embodiment has a control unit 31 and a vehicle information DB 32 as functional components of the server 30, as shown in FIG. 3.

Control unit 31 is achieved by processor 301 of server 30 executing a program stored in auxiliary storage unit 303. Note that the control unit 31 may be achieved by a hardware circuit such as an Application Specific Integrated Circuit (ASIC) or a Field Programmable Gate Array (FPGA).

The control unit 31 receives, through the communication unit 304, the travel information transmitted from the ECU 100 each time the first vehicle 10 finishes traveling for one trip. The travel information includes each detection value of the sensor group 41 during the trip, the date and time of the trip, the vehicle ID of the first vehicle 10, and the like, as described above.

Each time the control unit 31 receives travel information transmitted from the ECU 100, it calculates the driving time of the trip and the number of lane changes during the trip. The control unit 31 calculates the operation time of the trip based on the trip date and time (trip start date and time and trip end date and time) included in the travel information. The control unit 31 calculates the number of lane changes by a known method. For example, the control unit 31 may calculate the number of lane changes performed during the trip based on the detection value of the turn signal switch sensor, the detection value of the yaw rate sensor, and/or the imaging data of the camera, etc. included in the travel information. After calculating the driving time of the trip and the number of lane changes during the trip, the control unit 31 registers the information in the vehicle information DB 32, which will be described later.

Further, the control unit 31 executes driving diagnosis of the first user each time the first period of the first vehicle 10 ends, and transmits the diagnosis result to the user terminal 20. The first period of time may be, for example, days, weeks, or months. In this embodiment, an example in which the first period is one week will be described. The control unit 31 calculates the first frequency based on the information registered in the vehicle information DB 32 each time the first period ends. Specifically, the control unit 31 calculates the sum of the operating times of all trips (total operating time) during the first period. In addition, the control unit 31 calculates the sum of the number of lane changes performed in all trips during the first period (total number of times). The control unit 31 calculates the number of lane changes per unit time (first frequency) by dividing the total number of times by the total driving time.

Note that the total driving time and the total number of times used to calculate the first frequency described above may be calculated by excluding trips where the number of lane changes is below the lower limit value (for example, about 0 to 1 time). That is, the total driving time and the total number of trips may be calculated by excluding the driving time and the number of lane changes for trips in which the number of lane changes is less than the lower limit. This is because it is highly likely that the first vehicle 10 traveled on a single-lane road (a road on which lane changes cannot be made) in trips in which the number of lane changes is less than the lower limit. Further, when multiple trips are made on the same day, the total driving time and the total number of times may be calculated using only the driving time and the number of lane changes of the trip with the largest number of lane changes.

The control unit 31 executes a driving diagnosis (corresponding to a “first driving diagnosis” according to the present disclosure) based on the calculated first frequency. In this embodiment, the control unit 31 determines whether the first frequency is equal to or greater than the first threshold. The first threshold is a value at which it can be determined that the first user tends to change lanes easily if the first frequency is equal to or greater than the first threshold, and is, for example, about five times. When the first frequency is equal to or greater than the first threshold, the control unit 31 diagnoses that the first user tends to change lanes easily.

When the first frequency is less than the first threshold, the control unit 31 determines whether the first frequency is less than or equal to the second threshold. The second threshold is a value that allows it to be determined that the first user has a tendency to dislike lane changes and is smaller than the first threshold (for example, about twice), when the first frequency is equal to or less than the second threshold. When the first frequency is equal to or less than the second threshold, the control unit 31 diagnoses that the first user tends to have trouble changing lanes.

When the first frequency is less than the first threshold and the first frequency is greater than the second threshold, the control unit 31 diagnoses that the number of lane changes by the first user is appropriate.

After completing the driving diagnosis based on the first frequency, the control unit 31 transmits the diagnosis result to the user terminal 20. Note that when the first frequency is equal to or greater than the first threshold (when it is diagnosed that the first user tends to change lanes easily), and when the first frequency is equal to or less than the second threshold In (when it is diagnosed that the first user has a tendency to be difficult to change lanes), the control unit 31 transmits the first information to the user terminal 20 in addition to the diagnosis result.

The first information is information for recommending the first equipment. The first equipment is equipment for assisting driving operations related to lane changes and is equipment that can be attached to the first vehicle 10. An example of such first equipment is a BSM that detects a moving object positioned to the left and right rear of the first vehicle 10 and calls attention to it. The first information includes, for example, information on the function of the first equipment (e.g., textual information, diagrams, or videos explaining the function of the first equipment), and information on how to purchase the first equipment (for example, the Uniform Resource Locator (URL) of the sales site of the first equipment, etc.).

Next, the vehicle information DB 32 of the server 30 will be explained. The vehicle information DB 32 is a database constructed in the auxiliary storage unit 303 of the server 30 by the processor 301 of the server 30 executing a database management system (DBMS) program. Vehicle information DB 32 may be constructed as a relational database.

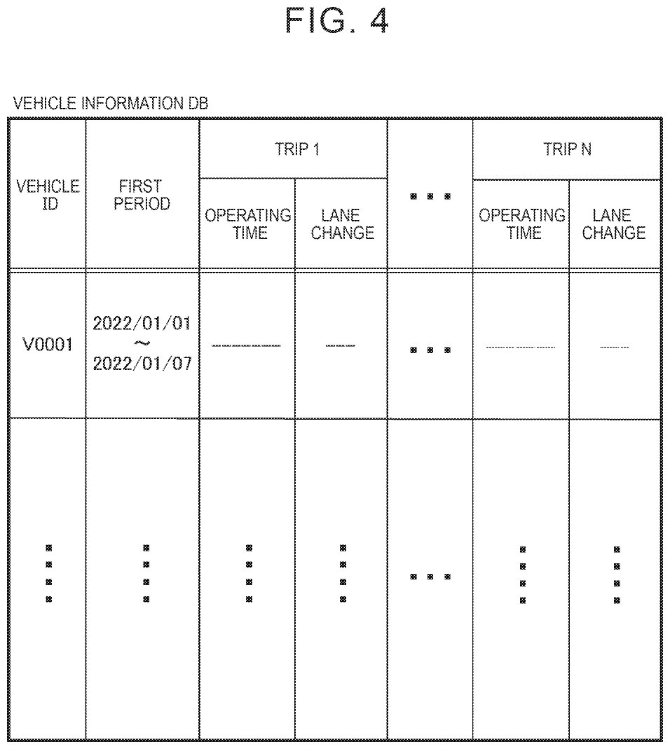

The vehicle information DB 32 in this embodiment stores information on the driving time and the number of lane changes in each trip during the first period for each vehicle. FIG. 4 is a diagram showing an example of information stored in the vehicle information DB 32 in this embodiment. As shown in FIG. 4, the vehicle information DB 32 in this embodiment has records for each vehicle (hereinafter sometimes referred to as “vehicle information records”). Each vehicle information record has fields such as vehicle ID, period, and trip, as shown in FIG. 4. A plurality of trip fields (e.g., N fields from trip 1 to trip N) are set for a vehicle that has traveled a plurality of trips (for example, N times) during the first period.

In the vehicle ID field of the vehicle information record, information (vehicle ID) for identifying each of the plurality of first vehicles 10 targeted for the driving diagnosis service is registered. Information indicating the date of the first period (the date of the first day of the first period and the date of the last day of the first period) is registered in the period field. The trip field is divided into subfields for drive time and lane change. The driving time field registers the driving time of the first vehicle 10 in each trip. The number of lane changes in each trip is registered in the lane change field. The information registered in the driving time field and the lane change field is information derived by the control unit 31 based on the travel information received from the ECU 100, as described above.

Note that in the present embodiment, the server 30 corresponds to the “information processing device” according to the present disclosure. The processor 301 of the server 30 corresponds to the “control unit” according to the present disclosure. Also, the user terminal 20 in this embodiment corresponds to the “first terminal” according to the present disclosure.

### Processing Flow

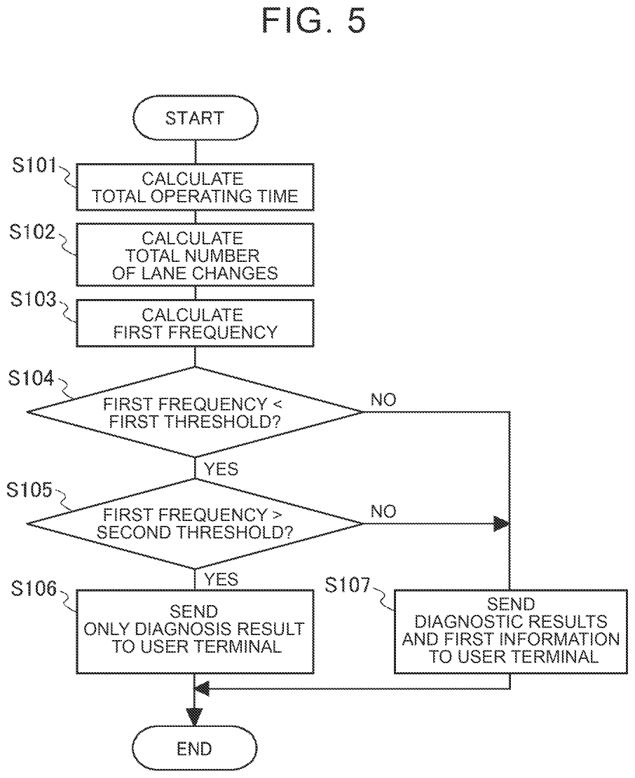

Next, the flow of processing executed by the server 30 will be described with reference to FIG. 5. FIG. 5 is a flowchart showing a processing routine executed by server 30 each time the first period for first vehicle 10 ends. Although the execution subject of the processing routine shown in FIG. 5 is the processor 301 of the server 30, the functional component (control unit 31) of the server 30 will be described here as the execution subject.

In FIG. 5, the control unit 31 of the server 30 calculates the total driving time of the first vehicle 10 during the first period (S101). Specifically, the control unit 31 accesses the vehicle information DB 32 and identifies a vehicle information record in which information matching the vehicle ID of the first vehicle 10 is registered in the vehicle ID field. The control unit 31 calculates the total driving time of the first vehicle 10 during the first period by totaling the driving times registered in the driving time fields of all trip fields in the identified vehicle information record. At that time, the control unit 31 may calculate the total driving time by excluding trip fields in which the number of times registered in the lane change field is less than the lower limit. After finishing executing the process of S101, the control unit 31 executes the process of S102.

In S102, the control unit 31 calculates the total number of lane changes of the first vehicle 10 during the first period. Specifically, the control unit 31 calculates the total number of lane changes of the first vehicle 10 during the first period by adding up the number of times registered in the lane change fields of all the trip fields in the vehicle information record identified in S101. At that time, the control unit 31 may calculate the total number of times by excluding trip fields in which the number of times registered in the lane change field is less than the lower limit. After finishing executing the process of S102, the control unit 31 executes the process of S103.

In S103, the control unit 31 divides the total number of lane changes calculated in S102 by the total driving time calculated in S101 to calculate the number of lane changes per unit time (first frequency). After finishing the process of S103, the control unit 31 executes the first driving diagnosis in S104 and S105.

In S104, the control unit 31 determines whether the first frequency calculated in S103 is less than the first threshold. When the first frequency is less than the first threshold (affirmative determination in S104), the control unit 31 executes the process of S105.

In S105, the control unit 31 determines whether the first frequency calculated in S103 is greater than the second threshold. When the first frequency is greater than the second threshold (affirmative determination in S105), the control unit 31 executes the process of S106.

In S106, the control unit 31 transmits the diagnosis result of the first driving diagnosis (diagnosis result that the number of lane changes by the first user is appropriate) to the user terminal 20 through the communication unit 304.

If a negative determination is made in S104 (if the first frequency is equal to or greater than the first threshold value), the control unit 31 proceeds to S107, and transmits the diagnosis result of the first driving diagnosis and the first information, It transmits to the user terminal 20 through the communication unit 304. It should be noted that the diagnosis result when a negative determination is made in S104 is the diagnosis result that the first user tends to change lanes easily.

Further, when a negative determination is made in S105 (when the first frequency is equal to or less than the second threshold), the control unit 31 proceeds to S107 to transmit the diagnosis result of the first driving diagnosis and the first information, and transmits to the user terminal 20 through the communication unit 304. It should be noted that the diagnosis result when a negative determination is made in S105 is the diagnosis result that the first user has a tendency to be not good at changing lanes.

After completing the processing of S106 or S107, the control unit 31 ends the execution of this processing routine.

### Actions and Effects of the Embodiment

In this embodiment, when it is diagnosed that the first user tends to change lanes easily, and when it is diagnosed that the first user tends to be difficult to change lanes, together with the diagnosis result First information is transmitted from the server 30 to the user terminal 20. In that case, the user terminal 20 presents the diagnosis result and the first information to the first user through the display 205. As a result, the first user can grasp the diagnosis result and can recognize that there is equipment (first equipment) suitable for assisting driving operations related to lane changes. As a result, users who tend to change lanes easily and users who tend not to change lanes easily can be encouraged to install the first equipment.

Therefore, according to the present embodiment, it is possible to contribute to improvement of safety when users who tend to change lanes easily and users who tend not to change lanes perform driving operations related to lane changes.

### Modified Examples

The first equipment described in the above embodiment is also effective for users who turn on their blinkers for a short period of time. The term “short-time blinker” as used herein refers to a driving operation in which the blinking time of the direction indicator is shorter than the proper time when changing lanes. Therefore, in this modified example, In addition to the first driving diagnosis, the second driving diagnosis is performed each time the first period ends.

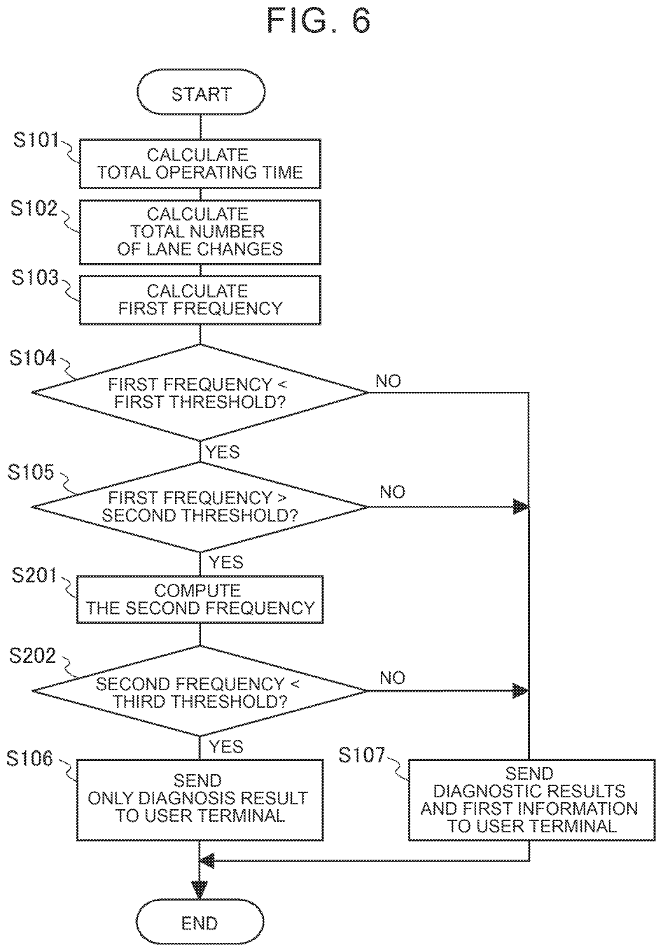

FIG. 6 is a flowchart showing an example of a processing routine executed by the server 30 in this modified example. The processing routine shown in FIG. 6 is executed by the server 30 each time the first period for the first vehicle 10 ends. In FIG. 6, the same reference numerals are assigned to the same processing as in FIG. 5 described above.

In FIG. 6, when the determination in S105 is affirmative, the control unit 31 of the server 30 executes the second driving diagnosis in S201 and S202. The process of S201 is executed. In S201, the control unit 31 calculates the second frequency. The second frequency is the number of short blinkers per trip in the first period. In calculating such a second frequency, the control unit 31 calculates the sum of the number of times the short blinkers are turned on for all trips during the first period. The control unit 31 calculates the second frequency by dividing the total value by the number of trips in the first period.

It should be noted that the number of times the short-time blinkers is operated in each trip in the first period may be registered in the vehicle information DB 32. At that time, the control unit 31 may calculate the number of times the blinker is operated for a short period of time based on each detection value of the sensor group 41 each time travel information for each trip is received. More specifically, the control unit 31 may derive the turn signal operating time at the time of lane change based on each detection value of the sensor group 41 (for example, the detection value of the turn signal switch sensor, the detection value of the yaw rate sensor, and/or the imaging data of the camera), and determine whether the turn signal operating time is shorter than the appropriate time. The control unit 31 may set the number of times that a lane change was performed for which the turn signal operating time was shorter than the appropriate time as the number of short turn signals.

After completing the processing of S201, the control unit 31 executes the processing of S202. In S202, the control unit 31 determines whether the second frequency is less than the third threshold (corresponding to the “third condition” according to the present disclosure). The third threshold is a value at which it can be determined that the first user tends to turn on the blinker for a short period of time if the second frequency is equal to or higher than the third threshold, and is, for example, about three times.

If the second frequency is less than the third threshold (affirmative determination in S202), the control unit 31 proceeds to S106, and transmits only the diagnosis result of the first driving diagnosis and the diagnosis result of the second driving diagnosis to the user terminal 20. The diagnosis result of the second driving diagnosis in this case is, for example, a diagnosis result that the blinker operation is appropriate when changing lanes.

If the second frequency is greater than or equal to the third threshold (negative determination in S202), the control unit 31 proceeds to S107, and in addition to the diagnosis result of the first driving diagnosis and the diagnosis result of the second driving diagnosis, first information is sent to the user terminal 20. The diagnosis result of the second driving diagnosis in this case is, for example, the diagnosis result that the turn signal operation at the time of lane change is inappropriate (the time from flashing the direction indicator to the start of lane change is short).

According to this modification, in addition to the user who tends to change lanes easily and the user who tends to be difficult to change lanes, the first equipment can also be recommended for the user who tends to turn on the blinker for a short time.

### Others

The above-described embodiments are merely examples, and the present disclosure may be appropriately modified and implemented without departing from the scope thereof. The processes and means described in the present disclosure can be freely combined and implemented as long as no technical contradiction occurs. Further, the processes described as being executed by one device may be shared and executed by a plurality of devices. For example, the computation of the first frequency and the second frequency may be performed by the ECU 100. Alternatively, the processes described as being executed by different devices may be executed by one device. In the computer system, it is possible to flexibly change the hardware configuration for implementing each function.

What is claimed is:

1. An information processing device comprising a control unit that executes:
acquiring a first frequency that is a frequency of a lane change per unit time of a first vehicle;
performing a first driving diagnosis based on the first frequency; and
transmitting first information and a result of the first driving diagnosis to a first terminal when the result of the first driving diagnosis satisfies a first condition, the first information being information about first equipment that is equipment for assisting a driving operation related to the lane change and is equipment that is able to be attached to the first vehicle.

2. The information processing device according to claim 1, wherein the control unit determines that the result of the first driving diagnosis satisfies the first condition when the first frequency is equal to or greater than a first threshold.

3. The information processing device according to claim 1, wherein the control unit determines that the result of the first driving diagnosis satisfies the first condition when the first frequency is equal to or less than a second threshold.

4. The information processing device according to claim 1, wherein the first equipment is equipment that detects a moving object positioned rightward behind and leftward behind the first vehicle and calls attention.

5. The information processing device according to claim 1, wherein the control unit further executes:
acquiring a turn signal operating time when the first vehicle changes lanes;
performing a second driving diagnosis based on the turn signal operating time; and
transmitting the first information and a result of the second driving diagnosis to the first terminal when the result of the second driving diagnosis satisfies a third condition.
